(19) United States
(12) Patent Application Publication
(10) Pub. No.: US 2014/0297264 A1
(43) Pub. Date: Oct. 2, 2014

(54) OPEN LANGUAGE LEARNING FOR INFORMATION EXTRACTION

(71) Applicant: UNIVERSITY OF WASHINGTON THROUGH IT CENTER FOR COMMERCIALIZATION, Seattle, WA (US)

(72) Inventors: Oren Etzioni, Seattle, WA (US); Robert E. Bart, Bellevue, WA (US); Mausum, Seattle, WA (US); Michael D. Schmitz, Langley, WA (US); Stephen G. Soderland, Bainbridge Island, WA (US)

(21) Appl. No.: 14/083,342

(22) Filed: Nov. 18, 2013

Related U.S. Application Data
(60) Provisional application No. 61/728,063, filed on Nov. 19, 2012.

(51) Int. Cl. G06F 17/27

(52) U.S. Cl. CPC G06F 17/271
USPC 704/9

(57) ABSTRACT

Open Information Extraction (IE) systems extract relational tuples from text, without requiring a pre-specified vocabulary, by identifying relation phrases and associated arguments in arbitrary sentences. However, state-of-the-art Open IE systems such as REVERB and WOE share two important weaknesses—(1) they extract only relations that are mediated by verbs, and (2) they ignore context, thus extracting tuples that are not asserted as factual. This paper presents OLLIE, a substantially improved Open IE system that addresses both these limitations. First, OLLIE achieves high yield by extracting relations mediated by nouns, adjectives, and more. Second, a context-analysis step increases precision by including contextual information from the sentence in the extractions. OLLIE obtains 2.7 times the area under precision-yield curve (AUC) compared to REVERB and 1.9 times the AUC of WOE^{parse}.

### CROSS-REFERENCE TO RELATED APPLICATION(S)

This application claims the benefit of U.S. Provisional Patent Application No. 61/728,063 (Attorney Docket No. 72227-8086.US00) filed Nov. 19, 2012, entitled “Open Language Learning for Information Extraction,” which is incorporated herein by reference in its entirety.

### STATEMENT OF GOVERNMENT INTEREST

This invention was made with government support under Grant No. FA8750-09-c-0179, awarded by the Defense Advanced Research Projects Agency (DARPA), Grant No. FA8650-10-7058, awarded by the Intelligence Advanced Research Projects Activity, Grant No. IIS-0803481, awarded by the National Science Foundation, and Grant No. N00014-08-1-0431 awarded by the Office of Naval Research (ONR). The government has certain rights in the invention.

### BACKGROUND AND SUMMARY OF INVENTION

### 1. Introduction

While traditional Information Extraction (IE) (ARPA, 1991; ARPA, 1998) focused on identifying and extracting specific relations of interest, there has been great interest in scaling IE to a broader set of relations and to far larger corpora (Banko et al., 2007; Hoffmann et al., 2010; Mintz et al., 2009; Carlson et al., 2010; Fader et al., 2011). However, the requirement of having pre-specified relations of interest is a significant obstacle. Imagine an intelligence analyst who recently acquired a terrorist's laptop or a news reader who wishes to keep abreast of important events. The substantial endeavor in analyzing their corpus is the discovery of important relations, which are likely not pre-specified. Open IE (Banko et al., 2007) is the state-of-the-art approach for such scenarios.

However, the state-of-the-art Open IE systems, REVERB (Fader et al., 2011; Etzioni et al., 2011) and WOE^{parse} (Wu and Weld, 2010) suffer from two key drawbacks. Firstly, they handle a limited subset of sentence constructions for expressing relationships. Both extract only relations that are mediated by verbs, and REVERB further restricts this to a subset of verbal patterns. This misses important information mediated via other syntactic entities such as nouns and adjectives, as well as a wider range of verbal structures (examples #1-3 in Table 1).

Secondly, REVERB and WOE^{parse} perform only a local analysis of a sentence, so they often extract relations that are not asserted as factual in the sentence (examples #4,5). This often occurs when the relation is within a belief, attribution, hypothetical or other conditional context.

In this paper we present OLLIE (Open Language Learning for Information Extraction),¹ our novel Open IE system that overcomes the limitations of previous Open IE by (1) expanding the syntactic scope of relation phrases to cover a much larger number of relation expressions, and (2) expanding the Open IE representation to allow additional context information such as attribution and clausal modifiers. OLLIE extractions obtain a dramatically higher yield at higher or comparable precision relative to existing systems. ¹ Available for download at http://openie.cs.washington.edu

The outline of the paper is as follows. First, we provide background on Open IE and how it relates to Semantic Role Labeling (SRL). Section 3 describes the syntactic scope expansion component, which is based on a novel approach that learns open pattern templates. These are relation-independent dependency parse-tree patterns that are automatically learned using a novel bootstrapped training set. Section 4 discusses the context analysis component, which is based on supervised training with linguistic and lexical features.

Section 5 compares OLLIE with REVERB and WOE^{parse} on a dataset from three domains: News, Wikipedia, and a Biology textbook. We find that OLLIE obtains 2.7 times the area in precision-yield curves (AUC) as REVERB and 1.9 times the AUC as WOE^{parse}. Moreover, for specific relations commonly mediated by nouns (e.g., ‘is the president of’) OLLIE obtains two order of magnitude higher yield. We also compare OLLIE to a state-of-the-art SRL system (Johansson and Nugues, 2008) on an IE-related end task and find that they both have comparable performance at argument identification and have complimentary strengths in sentence analysis. In Section 6 we discuss related work on pattern-based relation extraction.

TABLE 1
OLLIE (O) has a wider syntactic range and finds extractions for the
first three sentences where REVERB (R) and WOE^{parse} (W) find none. For
sentences #4, 5, REVERB and WOE^{parse} have an incorrect extraction by
ignoring the context that OLLIE explicitly represents.

| | |
|---|---|
| 1. | “After winning the Superbowl, the Saints are now the top dogs of |
| | the NFL.” |

O: (the Saints; win; the Superbowl)

| | |
|---|---|
| 2. | “There are plenty of taxis available at Bali airport.” |

O: (taxis; be available at; Bali airport)

| | |
|---|---|
| 3. | “Microsoft co-founder Bill Gates spoke at . . . ” |

O: (Bill Gates; be co-founder of; Microsoft)

| | |
|---|---|
| 4. | “Early astronomers believed that the earth is the center of the |
| | universe.” |

R: (the earth; be the center of; the universe)
W: (the earth; be; the center of the universe)
O: ((the earth; be the center of; the universe)

AttributedTo believe; Early astronomers)

| | |
|---|---|
| 5. | “If he wins five key states, Romney will be elected President.” |

R, W: (Romney; will be elected; President)
O: ((Romney; will be elected; President)

ClausalModifier if; he wins five key states)

### 2. Background

Open IE systems extract tuples consisting of argument phrases from the input sentence and a phrase from the sentence that expresses a relation between the arguments, in the format (arg1; rel; arg2). This is done without a pre-specified set of relations and with no domain-specific knowledge engineering. We compare OLLIE to two state-of-the-art Open IE systems: (1) REVERB (Fader et al., 2011), which uses shallow syntactic processing to identify relation phrases that begin with a verb and occur between the argument phrases;² (2) WOE^{parse} (Wu and Weld, 2010), which uses bootstrapping from entries in Wikipedia info-boxes to learn extraction patterns in dependency parses. Like REVERB, the relation phrases begin with verbs, but can handle long-range dependencies and relation phrases that do not come between the arguments. Unlike REVERB, WOE does not include nouns within the relation phrases (e.g., cannot represent ‘is the president of’ relation phrase). Both systems ignore context around the extracted relations that may indicate whether it is a supposition or conditionally true rather than asserted as factual (see #4-5 in Table 1). ² Available for download at http://reverb.cs.washington.edu/

The task of Semantic role labeling is to identify arguments of verbs in a sentence, and then to classify the arguments by mapping the verb to a semantic frame and mapping the argument phrases to roles in that frame, such as agent, patient, instrument, or benefactive. SRL systems can also identify and classify arguments of relations that are mediated by nouns when trained on NomBank annotations. Where SRL begins with a verb or noun and then looks for arguments that play roles with respect to that verb or noun, Open IE looks for a phrase that expresses a relation between a pair of arguments. That phrase is often more than simply a single verb, such as the phrase ‘plays a role in’, or ‘is the CEO of’.

### BRIEF DESCRIPTION OF THE DRAWINGS

FIG. 1 illustrates OLLIE's architecture.

FIG. 2 is a sample dependency parse.

FIG. 3 is a comparison of different Open IE systems.

FIG. 4 shows the results on the subset of extractions from patters with semantic/lexical restrictions.

FIG. 5 shows that context analysis increases precision.

### DETAILED DESCRIPTION

### 3. Relational Extraction in OLLIE

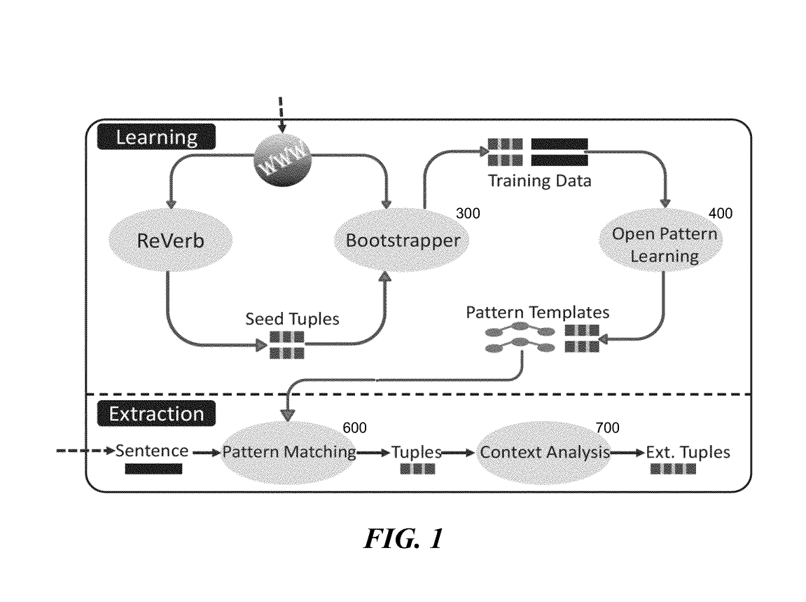

FIG. 1 illustrates OLLIE's architecture for learning and applying binary extraction patterns. First, it uses a set of high precision seed tuples from REVERB to bootstrap a large training set. Second, it learns open pattern templates over this training set. Next, OLLIE applies these pattern templates at extraction time. This section describes these three steps in detail. Finally, OLLIE analyzes the context around the tuple (Section 4) to add information (attribution, clausal modifiers) and a confidence function.

FIG. 1: System architecture: OLLIE begins with seed tuples from REVERB, uses them to build a bootstrap training set, and learns open pattern templates. These are applied to individual sentences at extraction time.

### 3.1 Constructing a Bootstrapping Set

Our goal is to automatically create a large training set, which encapsulates the multitudes of ways in which information is expressed in text. The key observation is that almost every relation can also be expressed via a REVERB-style verb-based expression. So, bootstrapping sentences based on REVERB's tuples will likely capture all relation expressions.

We start with over 110,000 seed tuples—these are high confidence REVERB extractions from a large Web corpus (ClueWeb)³ that are asserted at least twice and contain only proper nouns in the arguments. These restrictions reduce ambiguity while still covering a broad range of relations. For example, a seed tuple may be (Paul Annacone; is the coach of; Federer) that REVERB extracts from the sentence “Paul Annacone is the coach of Federer.”³ http://lemurproject.org/clueweb09.php/

For each seed tuple, we retrieve all sentences in a Web corpus that contains all content words in the tuple. We obtain a total of 18 million sentences. For our example, we will retrieve all sentences that contain ‘Federer’, ‘Paul’, ‘Annacone’ and some syntactic variation of ‘coach’. We may find sentences like “Now coached by Annacone, Federer is winning more titles than ever.”

Our bootstrapping hypothesis assumes that all these sentences express the information of the original seed tuple. This hypothesis is not always true. As an example, for a seed tuple (Boyle; is born in; Ireland) we may retrieve a sentence “Felix G. Wharton was born in Donegal, in the northwest of Ireland, a county where the Boyles did their schooling.”

To reduce bootstrapping errors we enforce additional dependency restrictions on the sentences. We only allow sentences where the content words from arguments and relation can be linked to each other via a linear path of size four in the dependency parse. To implement this restriction, we only use the subset of content words that are headwords in the parse tree. In the above sentence ‘Ireland’, ‘Boyle’ and ‘born’ connect via a dependency path of length six, and hence this sentence is rejected from the training set. This reduces our set to 4 million (seed tuple, sentence) pairs.

In our implementation, we use Malt Dependency Parser (Nivre and Nilsson, 2004) for dependency parsing, since it is fast and hence, easily applicable to a large corpus of sentences. We post-process the parses using Stanford's CC processed algorithm, which compacts the parse structure for easier extraction (de Marneffe et al., 2006).

We randomly sampled 100 sentences from our bootstrapping set and found that 90 of them satisfy our bootstrapping hypothesis (64 without dependency constraints). We find this quality to be satisfactory for our needs of learning general patterns.

Bootstrapped data has been previously used to generate positive training data for IE (Hoffmann et al., 2010; Mintz et al., 2009). However, previous systems retrieved sentences that only matched the two arguments, which is error-prone, since multiple relations can hold between a pair of entities (e.g., Bill Gates is the CEO of, a co-founder of, and has a high stake in Microsoft).

Alternatively, researchers have developed sophisticated probabilistic models to alleviate the effect of noisy data (Riedel et al., 2010; Hoffmann et al., 2011). In our case, by enforcing that a sentence additionally contains some syntactic form of the relation content words, our bootstrapping set is naturally much cleaner.

Moreover, this form of bootstrapping is better suited for Open IE's needs, as we will use this data to generalize to other unseen relations. Since the relation words in the sentence and seed match, we can learn general pattern templates that may apply to other relations too. We discuss this process next.

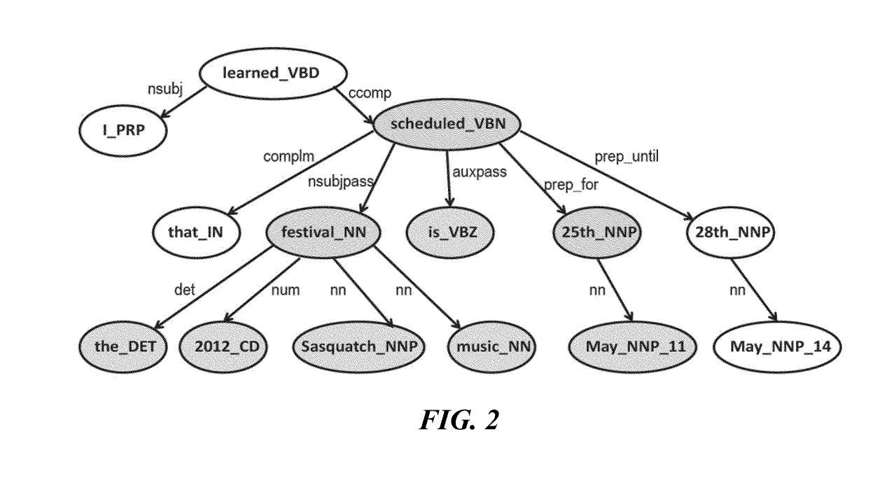

TABLE 2
Sample open pattern templates. Notice that some patterns
(1-3) are purely syntactic, and others are semantic/lexically
constrained (in bold font). A dependency parse that
matches pattern #1 is shown in FIG. 2.

| Extraction | |
|---|---|
| Template | Open Pattern |
| 1 . (arg1; be {rel} | {arg1} ↑nsubjpass↑ {rel:postag=VBN} |
| {prep}; arg2) | ↓{prep_ *}↓ {arg2} |
| 2. (arg1; | {arg1} ↑nsubj↑ {rel:postag=VBD} |
| {rel}; arg2) | ↓dobj↓ {arg2} |
| 3. (arg1; be | {arg1} ↑nsubjpass↑ {rel:postag=VBN} |
| {rel} by; arg2) | ↓agent↓ {arg2} |
| 4. (arg1; be | {rel:postag=NN;type=Person} ↑nn↑ {arg1} |
| {rel} of; arg2) | ↓nn↓ {arg2} |
| 5. (arg1; be {rel} | {arg1} ↑nsubjpass↑ {slot:postag=VBN;lex |
| {prep}; arg2) | ∈announce\|name\|choose...} |
| | ↓dobj↓ {rel:postag=NN} ↓{prep_*}↓ {arg2} |

### 3.2 Open Pattern Learning

OLLIE's next step is to learn general patterns that encode various ways of expressing relations. OLLIE learns open pattern templates—a mapping from a dependency path to an open extraction, i.e., one that identifies both the arguments and the exact (REVERB-style) relation phrase. Table 2 gives examples of high-frequency pattern templates learned by OLLIE. Note that some of the dependency paths are completely unlexicalized (#1-3), whereas in other cases some nodes have lexical or semantic restrictions (#4, 5).

Open pattern templates encode the ways in which a relation (in the first column) may be expressed in a sentence (second column). For example, a relation (Godse; kill; Gandhi) may be expressed with a dependency path (#2) {Godse}↑nsubj↑{kill:postag=VBD}↓dobj←{Gandhi}.

To learn the pattern templates, we first extract the dependency path connecting the arguments and relation words for each seed tuple and the associated sentence. We annotate the relation node in the path with the exact relation word (as a lexical constraint) and the POS (postag constraint). We create a relation template from the seed tuple by normalizing ‘is’/‘was’/‘will be’ to ‘be’, and replacing the relation content word with {rel}.⁴ ⁴ Our current implementation only allows a single relation content word; extending to multiple words is straightforward—the templates will require rel1, rel2, . . .

If the dependency path has a node that is not part of the seed tuple, we call it a slot node. Intuitively, if slot words do not negate the tuple they can be skipped over. As an example, ‘hired’ is a slot word for the tuple (Annacone; is the coach of; Federer) in the sentence “Federer hired Annacone as a coach”. We associate postag and lexical constraints with the slot node as well. (see #5 in Table 2).

Next, we perform several syntactic checks on each candidate pattern. These checks are the constraints that we found to hold in very general patterns, which we can safely generalize to other unseen relations. The checks are: (1) There are no slot nodes in the path. (2) The relation node is in the middle of arg1 and arg2. (3) The preposition edge (if any) in the pattern matches the preposition in the relation. (4) The path has no nn or amod edges.

If the checks hold true we accept it as a purely syntactic pattern with no lexical constraints. Others are semantic/lexical patterns and require further constraints to be reliable as extraction patterns.

### 3.2.1 Purely Syntactic Patterns

For syntactic patterns, we aggressively generalize to unseen relations and prepositions. We remove all lexical restrictions from the relation nodes. We convert all preposition edges to an abstract {prep_*} edge. We also replace the specific prepositions in extraction templates with {prep}.

As an example, consider the sentences, “Michael Webb appeared on Oprah . . . ” and “ . . . when Alexander the Great advanced to Babylon.” and associated seed tuples (Michael Webb; appear on; Oprah) and (Alexander; advance to; Babylon). Both these data points return the same open pattern after generalization: “{arg1} ↑nsubj↑ {rel:postag=VBD} ↓{prep_*}↓ {arg2}” with the extraction template (arg1, {rel} {prep}, arg2). Other examples of syntactic pattern templates are #1-3 in Table 2.

### 3.2.2 Semantic/Lexical Patterns

Patterns that do not satisfy the checks are not as general as those that do, but are still important. Constructions like “Microsoft co-founder Bill Gates . . . ” work for some relation words (e.g., founder, CEO, director, president, etc.) but would not work for other nouns; for instance, from “Chicago Symphony Orchestra” we should not conclude that (Orchestra; is the Symphony of; Chicago).

Similarly, we may conclude (Annacone; is the coach of; Federer) from the sentence “Federer hired Annacone as a coach.”, but this depends on the semantics of the slot word, ‘hired’. If we replaced ‘hired’ by ‘fired’ or ‘considered’ then the extraction would be false.

To enable such patterns we retain the lexical constraints on the relation words and slot words.⁵ We collect all patterns together based only on the syntactic restrictions and convert the lexical constraint into a list of words with which the pattern was seen. Example #5 in Table 2 shows one such lexical list. ⁵ For highest precision extractions, we may also need semantic constraints on the arguments. In this work, we increase our yield by ignoring the argument-type constraints.

Can we generalize these lexically-annotated patterns further? Our insight is that we can generalize a list of lexical items to other similar words. For example, if we see a list like {CEO, director, president, founder}, then we should be able to generalize to ‘chairman’ or ‘minister’.

Several ways to compute semantically similar words have been suggested in the literature like Wordnet-based, distributional similarity, etc. (e.g., (Resnik, 1996; Dagan et al., 1999; Ritter et al., 2010)). For our proof of concept, we use a simple overlap metric with two important Wordnet classes—Person and Location. We generalize to these types when our list has a high overlap (>75%) with hyponyms of these classes. If not, we simply retain the original lexical list without generalization. Example #4 in Table 2 is a type-generalized pattern.

We combine all syntactic and semantic patterns and sort in descending order based on frequency of occurrence in the training set. This imposes a natural ranking on the patterns—more frequent patterns are likely to give higher precision extractions.

### 3.3 Pattern Matching for Extraction

We now describe how these open patterns are used to extract binary relations from a new sentence. We first match the open patterns with the dependency parse of the sentence and identify the base nodes for arguments and relations. We then expand these to convey all the information relevant to the extraction.

As an example, consider the sentence: “I learned that the 2012 Sasquatch music festival is scheduled for May 25th until May 28th.” FIG. 2 illustrates the dependency parse. To apply pattern #1 from Table 2 we first match arg1 to ‘festival’, rel to ‘scheduled’ and arg2 to ‘25th’ with prep ‘for’. However, (festival, be scheduled for, 25th) is not a very meaningful extraction. We need to expand this further.

For the arguments we expand on amod, nn, det, neg, prep_of, num, quantmod edges to build the noun-phrase. When the base noun is not a proper noun, we also expand on rcmod, infmod, partmod, ref, prepc_of edges, since these are relative clauses that convey important information. For relation phrases, we expand on advmod, mod, aux, auxpass, cop, prt edges. We also include dobj and iobj in the case that they are not in an argument. After identifying the words in arg/relation we choose their order as in the original sentence. For example, these rules will result in the extraction (the Sasquatch music festival; be scheduled for; May 25th).

FIG. 2: A sample dependency parse. The colored/greyed nodes represent all words that are extracted from the pattern {arg1} ↑nsubjpass↑ {rel:postag=VBN} ↓{prep_*}↓ {arg2}. The extraction is (the 2012 Sasquatch Music Festival; is scheduled for; May 25th).

3.4 Comparison with WOE^{parse}

OLLIE's algorithm is similar to that of WOE^{parse}—both systems follow the basic structure of bootstrap learning of patterns based on dependency parse paths. However, there are three significant differences. WOE uses Wikipedia-based bootstrapping, finding a sentence in a Wikipedia article that contains the infobox values. Since WOE does not have access to a seed relation phrase, it heuristically assigns all intervening words between the arguments in the parse as the relation phrase. This often results in under-specified or nonsensical relation phrases. For example, from the sentence “David Miscavige learned that after Tom Cruise divorced Mimi Rogers, he was pursuing Nicole Kidman.” WOE's heuristics will extract the relation divorced was pursuing between ‘Tom Cruise’ and ‘Nicole Kidman’. OLLIE, in contrast, produces well-formed relation phrases by basing its templates on REVERB relation phrases.

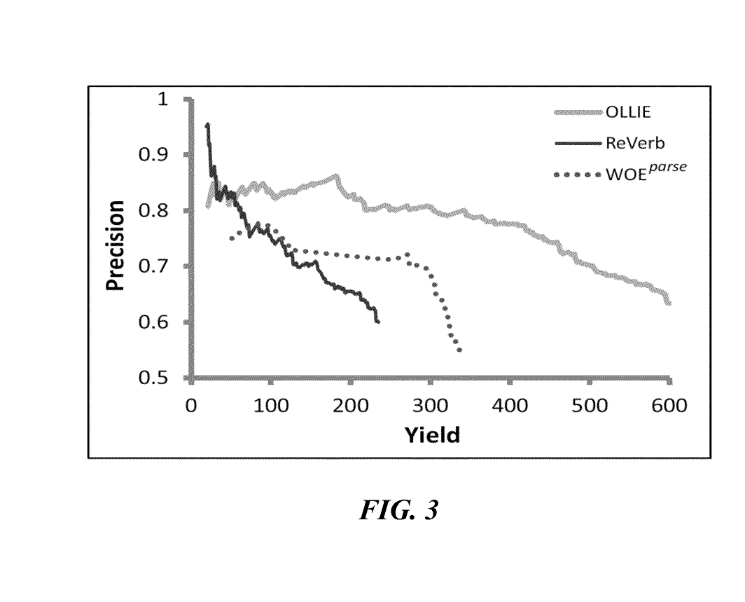

Secondly, WOE does not assign semantic/lexical restrictions to its patterns, and thus, has lower precision due to aggressive syntactic generalization. Finally, WOE is designed to have verb-mediated relation phrases that do not include nouns, thus missing important relations such as ‘is the president of’. In our experiments (see FIG. 3) we find WOE^{parse} to have lower precision and yield than OLLIE.

### 4. Context Analysis in OLLIE

We now turn to the context analysis component, which handles the problem of extractions that are not asserted as factual in the text. In some cases, OLLIE can handle this by extending the tuple representation with an extra field that turns an otherwise incorrect tuple into a correct one. In other cases, there is no reliable way to salvage the extraction, and OLLIE can avoid an error by giving the tuple a low confidence.

Cases where OLLIE extends the tuple representation include conditional truth and attribution. Consider sentence #4 in Table 1. It is not asserting that the earth is the center of the universe. OLLIE adds an AttributedTo field, which makes the final extraction valid (see OLLIE extraction in Table 1). This field indicates who said, suggested, believes, hopes, or doubts the information in the main extraction.

Another case is when the extraction is only conditionally true. Sentence #5 in Table 1 does not assert as factual that (Romney; will be elected; President), so it is an incorrect extraction. However, adding a condition (“if he wins five states”) can turn this into a correct extraction. We extend OLLIE to have a ClausalModifier field when there is a dependent clause that modifies the main extraction.

Our approach for extracting these additional fields makes use of the dependency parse structure. We find that attributions are marked by a ccomp (clausal complement) edge. For example, in the parse of sentence #4 there is a ccomp edge between ‘believe’ and ‘center’. Our algorithm first checks for the presence of a ccomp edge to the relation node. However, not all ccomp edges are attributions. We match the context verb (e.g., ‘believe’) with a list of communication and cognition verbs from VerbNet (Schuler, 2006) to detect attributions. The context verb and its subject then populate the AttributedTo field.

Similarly, the clausal modifiers are marked by advcl (adverbial clause) edge. We filter these lexically, and add a ClausalModifier field when the first word of the clause matches a list of 16 terms created using a training set: {if, when, although, because, . . . }.

OLLIE has high precision for AttributedTo and ClausalModifier fields, nearly 98% on a development set, however, these two fields do not cover all the cases where an extraction is not asserted as factual. To handle others, we train OLLIE's confidence function to reduce the confidence of an extraction if its context indicates it is likely to be non-factual.

We use a supervised logistic regression classifier for the confidence function. Features include the frequency of the extraction pattern, the presence of AttributedTo or ClausalModifier fields, and the position of certain words in the extraction's context, such as function words or the communication and cognition verbs used for the AttributedTo field. For example, one highly predictive feature tests whether or not the word ‘if’ comes before the extraction when no ClausalModifier fields are attached. Our training set was 1000 extractions drawn evenly from Wikipedia, News, and Biology sentences.

### 5. Experiments

Our experiments evaluate three main questions. (1) How does OLLIE's performance compare with existing state-of-the-art open extractors? (2) What are the contributions of the different sub-components within OLLIE? (3) How do OLLIE's extractions compare with semantic role labeling argument identification?

### 5.1 Comparison of Open IE Systems

Since Open IE is designed to handle a variety of domains, we create a dataset of 300 random sentences from three sources: News, Wikipedia and Biology textbook. The News and Wikipedia test sets are a random subset of Wu and Weld's test set for WOE^{parse}. We ran three systems, OLLIE, REVERB and WOE^{parse} on this dataset resulting in a total of 1,945 extractions from all three systems. Two annotators tagged the extractions as correct if the sentence asserted or implied that the relation was true. Inter-annotator agreement was 0.96, and we retained the subset of extractions on which the two annotators agree for further analysis.

All systems associate a confidence value with an extraction—ranking with these confidence values generates a precision-yield curve for this dataset. FIG. 3 reports the curves for the three systems.

We find that OLLIE has a higher performance, owing primarily to its higher yield at comparable precision. OLLIE finds 4.4 times more correct extractions than REVERB and 4.8 times more than WOE^{parse} at a precision of about 0.75. Overall, OLLIE has 2.7 times larger area under the curve than REVERB and 1.9 times larger than WOE^{parse}.⁶ We use the Bootstrap test (Cohen, 1995) to find that OLLIE's better performance compared to the two systems is highly statistically significant. We perform further analysis to understand the reasons behind the high yield from OLLIE. We find that 40% of the OLLIE extractions that REVERB misses are due to OLLIE's use of parsers—REVERB misses those because its shallow syntactic analysis cannot skip over the intervening clauses or prepositional phrases between the relation phrase and the arguments. About 30% of the additional yield is those extractions where the relation is not between its arguments (see instance #1 in Table 1). The rest are due to other causes such as OLLIE's ability to handle relationships mediated by nouns and adjectives, or REVERB's shallow syntactic analysis, etc. In contrast, OLLIE misses very few extractions returned by REVERB, mostly due to parser errors. ⁶ Evaluating recall is difficult at this scale—however, since yield is proportional to recall, the area differences also hold for the equivalent precision-recall curves.

We find that WOE^{parse} misses extractions found by OLLIE for a variety of reasons. The primary cause is that WOE^{parse} does not include nouns in relation phrases. It also misses some verb-based patterns, probably due to training noise. In other cases, WOE^{parse} misses extractions due to ill-formed relation phrases (as in the example of Section 3.4: ‘divorced was pursuing’ instead of the correct relation ‘was pursuing’).

While the bulk of OLLIE's extractions in our test set were verb-mediated, our intuition suggests that there exist many relationships that are most naturally expressed via noun phrases. To demonstrate this effect, we chose four such relations—is capital of, is president of, is professor at, and is scientist of. We ran our systems on 100 million random sentences from the ClueWeb corpus. Table 3 reports the yields of these four relations.⁷ ⁷ We multiply the total number of extractions with precision on a sample for that relation to estimate the yield.

OLLIE found up to 146 times as many extractions for these relations than REVERB. Because WOE^{parse} does not include nouns in relation phrases, it is unable to extract any instance of these relations. We examine a sample of the extractions to verify that noun-mediated extractions are the main reason for this large yield boost over REVERB (73% of OLLIE extractions were noun-mediated). High-frequency noun patterns like “Obama, the president of the US”, “Obama, the US president”, “US President Obama” far outnumber sentences of the form “Obama is the president of the US”. These relations are seldom the primary information in a sentence, and are typically mentioned in passing in noun phrases that express the relation.

For some applications, noun-mediated relations are important, as they associate people with work places and job titles. Overall, we think of the results in Table 3 as a “best case analysis” that illustrates the dramatic increase in yield for certain relations, due to syntactic scope expansion in Open IE.

FIG. 3: Comparison of different Open IE systems. OLLIE achieves substantially larger area under the curve than other Open IE systems.

TABLE 3
OLLIE finds many more correct extractions for relations that are
typically expressed by noun phrases - up to 146 times that of REVERB.
WOE^{parse} outputs no instances of these, because it does not allow
nouns in the relation. These results are at point of maximum yield
(with comparable precisions around 0.66).

| Relation | OLLIE | REVERB | incr. |
|---|---|---|---|
| is capital of | 8,566 | 146 | 59x |
| is president of | 21,306 | 1,970 | 11x |
| is professor at | 8,334 | 400 | 21x |
| is scientist of | 730 | 5 | 146x |

### 5.2 Analysis of OLLIE

We perform two control experiments to understand the value of semantic/lexical restrictions in pattern learning and precision boost due to context analysis component.

Are semantic restrictions important for open pattern learning? How much does type generalization help? To answer these questions we compare three systems—OLLIE without semantic or lexical restrictions (OLLIE[syn]), OLLIE with lexical restrictions but no type generalization (OLLIE[lex]) and the full system (OLLIE). We restrict this experiment to the patterns where OLLIE adds semantic/lexical restrictions, rather than dilute the result with patterns that would be unchanged by these variants.

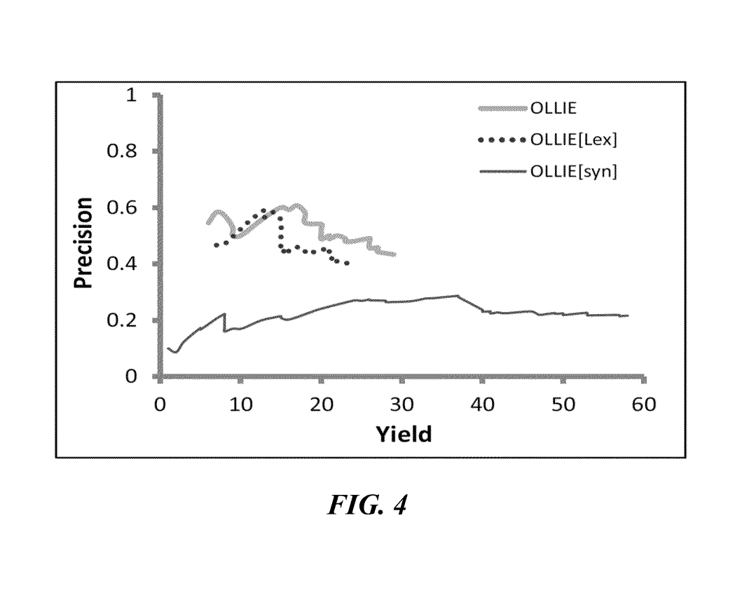

FIG. 4 shows the results of this experiment on our dataset from three domains. As the curves show, OLLIE was correct to add lexical/semantic constraints to these patterns—precision is quite low without the restrictions. This matches our intuition, since these are not completely general patterns and generalizing to all unseen relations results in a large number of errors. OLLIE[lex] performs well though at lower yield. The type generalization helps the yield somewhat, without hurting the precision. We believe that a more data-driven type generalization that uses distributional similarity (e.g., (Ritter et al., 2010)) may help much more. Also, notice that overall precision numbers are lower, since these are the more difficult relations to extract reliably. We conclude that lexical/semantic restrictions are valuable for good performance of OLLIE.

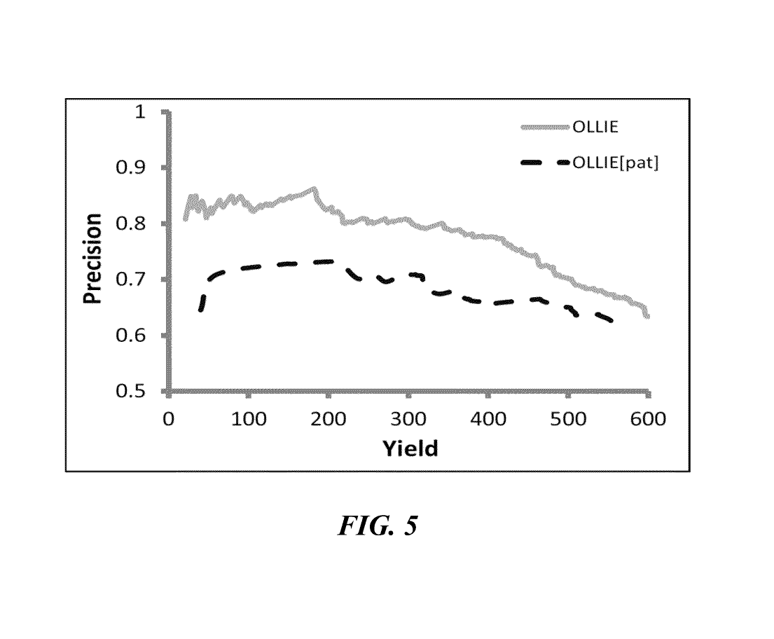

We also compare our full system to a version that does not use the context analysis of Section 4. FIG. 5 compares OLLIE to a version (OLLIE[pat]) that does not add the AttributedTo and ClausalModifier fields, and, instead of context-sensitive confidence function, uses the pattern frequency in the training set as a ranking function. 10% of the sentences have an OLLIE extraction with ClausalModifier and 6% have AttributedTo fields. Adding ClausalModifier corrects errors for 21% of extractions that have a ClausalModifier and does not introduce any new errors. Adding AttributedTo corrects errors for 55% of the extractions with AttributedTo and introduces an error for 3% of the extractions. Overall, we find that OLLIE gives a significant boost to precision over OLLIE[pat] and obtains 19% additional AUC.

Finally, we analyze the errors made by OLLIE. Unsurprisingly, because of OLLIE's heavy reliance on the parsers, parser errors account for a large part of OLLIE's errors (32%). 18% of the errors are due to aggressive generalization of a pattern to all unseen relations and 12% due to incorrect application of lexically annotated patterns. About 14% of the errors are due to important context missed by OLLIE. Another 12% of the errors are because of the limitations of binary representation, which misses important information that can only be expressed in n-ary tuples.

We believe that as parsers become more robust OLLIE's performance will improve even further. The presence of context-related errors suggests that there is more to investigate in context analysis. Finally, in the future we wish to extend the representation to include n-ary extractions.

FIG. 4: Results on the subset of extractions from patterns with semantic/lexical restrictions. Ablation study on patterns with semantic/lexical restrictions. These patterns without restrictions (OLLIE[syn]) result in low precision. Type generalization improves yield compared to patterns with only lexical constraints (OLLIE[lex]).

FIG. 5: Context analysis increases precision, raising the area under the curve by 19%.

5.3 Comparison with SRL

Our final evaluation suggests answers to two important questions. First, how does a state-of-the-art Open IE system do in terms of absolute recall? Second, how do Open IE systems compare against state-of-the-art SRL systems?

SRL, as discussed in Section 2, has a very different goal—analyzing verbs and nouns to identify their arguments, then mapping the verb or noun to a semantic frame and determining the role that each argument plays in that frame. These verbs and nouns need not make the full relation phrase, although, recent work has shown that they may be converted to Open IE style extractions with additional post-processing (Christensen et al., 2011).

While a direct comparison between OLLIE and a full SRL system is problematic, we can compare performance of OLLIE and the argument identification step of an SRL system. We set each system the following task—“based on a sentence, find all noun-pairs that have an asserted relationship.” This task is permissive for both systems, as it does not require finding an exact relation phrase or argument boundary, or determining the argument roles in a relation.

We create a gold standard by tagging a random 50 sentences of our test set to identify all pairs of NPs that have an asserted relation. We only counted relation expressed by a verb or noun in the text, and did not include relations expressed simply with “of” or apostrophe-s. Where a verb mediates between an argument and multiple NPs, we represent this as a binary relation for all pairs of NPs.

For example the sentence, “Macromolecules translocated through the phloem include proteins and various types of RNA that enter the sieve tubes through plasmodesmata.” has five binary relations.

| arg1: | arg2: | relation term |
|---|---|---|
| Macromolecules | phloem | translocated |
| Macromolecules | proteins | include |
| Macromolecules | types of RNA | include |
| types of RNA | sieve tubes | enter |
| types of RNA | plasmodesmata | enter |

We find an average of 4.0 verb-mediated relations and 0.3 noun-mediated relations per sentence. Evaluating OLLIE against this gold standard helps to answer the question of absolute recall: what percentage of binary relations expressed in a sentence can our systems identify.

For comparison, we use a state-of-the-art SRL system from Lund University (Johansson and Nugues, 2008), which is trained on PropBank (Martha and Palmer, 2002) for its verb-frames and NomBank (Meyers et al., 2004) for noun-frames. The PropBank version of the system won the very competitive 2008 CONLL SRL evaluation. We conduct this experiment by manually comparing the outputs of LUND and OLLIE against the gold standard. For each pair of NPs in the gold standard we determine whether the systems find a relation with that pair of NPs as arguments. Recall is based on the percentage of NP pairs where the head nouns matches head nouns of two different arguments in an extraction or semantic frame. If the argument value is conjunctive, we count a match against the head noun of each item in the list. We also count cases where system output would match the gold standard, given perfect co-reference.

Table 4 shows the recall for OLLIE and LUND, with recall based on oracle co-referential matches in parentheses. Our analysis shows strong recall for both systems for verb-mediated relations: LUND finding about two thirds of the argument pairs and OLLIE finding over half. Both systems have low recall for noun-mediated relations, with most of LUND's recall requiring co-reference. We observe that a union of the two systems raises recall to 0.71 for verb-mediated relations and 0.83 with co-reference, demonstrating that each system is identifying argument pairs that the other missed.

It is not surprising that OLLIE has recall of approximately 0.5, since it is tuned for high precision extraction, and avoids less reliable extractions from constructions such as reduced relative clauses and gerunds, or from noun-mediated relations with long-range dependencies. In contrast, SRL is tuned to identify the argument structure for nearly all verbs and nouns in a sentence. The missing recall from SRL is primarily where it does not identify both arguments of a binary relation, or where the correct argument is buried in a long argument phrase, but is not its head noun.

It is surprising that LUND, trained on NomBank, identifies so few noun-mediated argument pairs without co-reference. An example will make this clear. For the sentence, “Clarcor, a maker of packaging and filtration products, said . . . ”, the target relation is between Clarcor and the products it makes. LUND identifies a frame maker.01 in which argument A0 has head noun ‘maker’ and A1 is a PP headed by ‘products’, missing the actual name of the maker without co-reference post-processing. OLLIE finds the extraction (Clarcor; be a maker of; packaging and filtration products) where the heads of both arguments matched those of the target. In another example, LUND identifies “his” and “brother” as the arguments of the frame brother.01, rather than the actual names of the two brothers.

We can draw several conclusions from this experiment. First, nouns, although less frequently mediating relations, are much harder and both systems are failing significantly on those—OLLIE is somewhat better. Two, neither systems dominates the other; in fact, recall is increased significantly by a union of the two. Three, and probably most importantly, significant information is still being missed by both systems, and more research is warranted.

TABLE 4
Recall of LUND and OLLIE on binary relations. In parentheses
is recall with oracle co-reference. Both systems identify
approximately half of all argument pairs, but have lower
recall on noun-mediated relations.

| | LUND | OLLIE | union |
|---|---|---|---|
| Verb relations | 0.58 (0.69) | 0.49 (0.55) | 0.71 (0.83) |
| Noun relations | 0.07 (0.33) | 0.13 (0.13) | 0.20 (0.33) |
| All relations | 0.54 (0.67) | 0.47 (0.52) | 0.67 (0.80) |

### 6. Related Work

There is a long history of bootstrapping and pattern learning approaches in traditional information extraction, e.g., DIPRE (Brin, 1998), SnowBall (Agichtein and Gravano, 2000), Espresso (Pantel and Pennacchiotti, 2006), PORE (Wang et al., 2007), SOFIE (Suchanek et al., 2009), NELL (Carlson et al., 2010), and PROSPERA (Nakashole et al., 2011). All these approaches first bootstrap data based on seed instances of a relation (or seed data from existing resources such as Wikipedia) and then learn lexical or lexico-POS patterns to create an extractor. Other approaches have extended these to learning patterns based on full syntactic analysis of a sentence (Bunescu and Mooney, 2005; Suchanek et al., 2006; Zhao and Grishman, 2005).

OLLIE has significant differences from the previous work in pattern learning. First, and most importantly, these previous systems learn an extractor for each relation of interest, whereas OLLIE is an open extractor. OLLIE's strength is its ability to generalize from one relation to many other relations that are expressed in similar forms. This happens both via syntactic generalization and type generalization of relation words (sections 3.2.1 and 3.2.2). This capability is essential as many relations in the test set are not even seen in the training set—in early experiments we found that non-generalized pattern learning (equivalent to traditional IE) had significantly less yield at a slightly higher precision.

Secondly, previous systems begin with seeds that consist of a pair of entities, whereas we also include the content words from REVERB relations in our training seeds. This results in a much higher precision bootstrapping set and high rule precision while still allowing morphological variants that cover noun-mediated relations. A third difference is in the scale of the training—REVERB yields millions of training seeds, where previous systems had orders of magnitude less. This enables OLLIE to learn patterns with greater coverage.

The closest to our work is the pattern learning based open extractor WOE^{parse}. Section 3.4 details the differences between the two extractors. Another extractor, StatSnowBall (Zhu et al., 2009), has an Open IE version, which learns general but shallow patterns. Preemptive IE (Shinyama and Sekine, 2006) is a paradigm related to Open IE that first groups documents based on pairwise vector clustering, then applies additional clustering to group entities based on document clusters. The clustering steps make it difficult for it to scale to large corpora.

### 7. CONCLUSIONS

Our work describes OLLIE, a novel Open IE extractor that makes two significant advances over the existing Open IE systems. First, it expands the syntactic scope of Open IE systems by identifying relationships mediated by nouns and adjectives. Our experiments found that for some relations this increases the number of correct extractions by two orders of magnitude. Second, by analyzing the context around an extraction, OLLIE is able to identify cases where the relation is not asserted as factual, but is hypothetical or conditionally true. OLLIE increases precision by reducing confidence in those extractions or by associating additional context in the extractions, in the form of attribution and clausal modifiers. Overall, OLLIE obtains 1.9 to 2.7 times more area under precision-yield curves compared to existing state-of-the-art open extractors. OLLIE is available for download at http://openie.cs.washington.edu.

### REFERENCES

E. Agichtein and L. Gravano. 2000. Snowball: Extracting relations from large plain-text collections. In Procs. of the Fifth ACM International Conference on Digital Libraries.
ARPA. 1991. Proc. 3rd Message Understanding Conf. Morgan Kaufmann.
ARPA. 1998. Proc. 7th Message Understanding Conf. Morgan Kaufmann.
M. Banko, M. Cafarella, S. Soderland, M. Broadhead, and O. Etzioni. 2007. Open information extraction from the Web. In Procs. of IJCAI.
S. Brin. 1998. Extracting Patterns and Relations from the World Wide Web. In WebDB Workshop at 6th International Conference on Extending Database Technology, EDBT'98, pages 172-183, Valencia, Spain.
Razvan C. Bunescu and Raymond J. Mooney. 2005. A shortest path dependency kernel for relation extraction. In Proc. of HLT/EMNLP.
Andrew Carlson, Justin Betteridge, Bryan Kisiel, Burr Settles, Estevam R. Hruschka Jr., and Tom M. Mitchell. 2010. Toward an architecture for never-ending language learning. In Procs. of AAAI.
Janara Christensen, Mausam, Stephen Soderland, and Oren Etzioni. 2011. An analysis of open information extraction based on semantic role labeling. In Proceedings of the 6th International Conference on Knowledge Capture (K-CAP '11).
Paul R. Cohen. 1995. Empirical Methods for Artificial Intelligence. MIT Press.
Ido Dagan, Lillian Lee, and Fernando C. N. Pereira. 1999. Similarity-based models of word cooccurrence probabilities. Machine Learning, 34(1-3):43-69.
Marie-Catherine de Marneffe, Bill MacCartney, and Christopher D. Manning. 2006. Generating typed dependency parses from phrase structure parses. In Language Resources and Evaluation (LREC 2006).
Oren Etzioni, Anthony Fader, Janara Christensen, Stephen Soderland, and Mausam. 2011. Open information extraction: the second generation. In Proceedings of the International Joint Conference on Artificial Intelligence (IJCAI '11).
Anthony Fader, Stephen Soderland, and Oren Etzioni. 2011. Identifying relations for open information extraction. In Proceedings of EMNLP.
Raphael Hoffmann, Congle Zhang, and Daniel S. Weld. 2010. Learning 5000 relational extractors. In Proceedings of the 48th Annual Meeting of the Association for Computational Linguistics, ACL '10, pages 286-295.
Raphael Hoffmann, Congle Zhang, Xiao Ling, Luke S. Zettlemoyer, and Daniel S. Weld. 2011. Knowledge-based weak supervision for information extraction of overlapping relations. In ACL, pages 541-550.
Richard Johansson and Pierre Nugues. 2008. The effect of syntactic representation on semantic role labeling. In Proceedings of the 22nd International Conference on Computational Linguistics (COLING 08), pages 393-400.
Paul Kingsbury Martha and Martha Palmer. 2002. From treebank to propbank. In Proceedings of the Third International Conference on Language Resources and Evaluation (LREC 02).
A. Meyers, R. Reeves, C. Macleod, R. Szekely, V. Zielinska, B. Young, and R. Grishman. 2004. Annotating Noun Argument Structure for NomBank. In Proceedings of LREC-2004, Lisbon, Portugal.
Mike Mintz, Steven Bills, Rion Snow, and Dan Jurafsky.
2009. Distant supervision for relation extraction without labeled data. In ACL-IJCNLP '09: Proceedings of the Joint Conference of the 47th Annual Meeting of the ACL and the 4th International Joint Conference on Natural Language Processing of the AFNLP: Volume 2, pages 1003-1011.
Ndapandula Nakashole, Martin Theobald, and Gerhard Weikum. 2011. Scalable knowledge harvesting with high precision and high recall. In Proceedings of the Fourth International Conference on Web Search and Web Data Mining (WSDM 2011), pages 227-236.
Joakim Nivre and Jens Nilsson. 2004. Memory-based dependency parsing. In Proceedings of the Conference on Natural Language Learning (CoNLL-04), pages 49-56.
Patrick Pantel and Marco Pennacchiotti. 2006. Espresso: Leveraging generic patterns for automatically harvesting semantic relations. In Proceedings of 21st International Conference on Computational Linguistics and 44th Annual Meeting of the Association for Computational Linguistics (ACL'06).
P. Resnik. 1996. Selectional constraints: an information-theoretic model and its computational realization. Cognition.
Sebastian Riedel, Limin Yao, and Andrew McCallum. 2010. Modeling relations and their mentions without labeled text. In ECML/PKDD (3), pages 148-163.
Alan Ritter, Mausam, and Oren Etzioni. 2010. A latent dirichlet allocation method for selectional preferences. In Proceedings of the 48th Annual Meeting of the Association for Computational Linguistics (ACL '10).
Karin Kipper Schuler. 2006. VerbNet: A Broad-Coverage, Comprehensive Verb Lexicon. Ph. D. thesis, University of Pennsylvania.
Y. Shinyama and S. Sekine. 2006. Preemptive information extraction using unrestricted relation discovery. In Procs. of HLT/NAACL.
Fabian M. Suchanek, Georgiana Ifrim, and Gerhard Weikum. 2006. Combining linguistic and statistical analysis to extract relations from web documents. In Procs. of KDD, pages 712-717.
Fabian M. Suchanek, Mauro Sozio, and Gerhard Weikum. 2009. Sofie: a self-organizing framework for information extraction. In Proceedings of WWW, pages 631-640.
Gang Wang, Yong Yu, and Haiping Zhu. 2007. Pore: Positive-only relation extraction from wikipedia text. In Proceedings of 6th International Semantic Web Conference and 2nd Asian Semantic Web Conference (ISWC/ASWC'07), pages 580-594.
Fei Wu and Daniel S. Weld. 2010. Open information extraction using Wikipedia. In Proceedings of the 48th Annual Meeting of the Association for Computational Linguistics (ACL '10).
Shubin Zhao and Ralph Grishman. 2005. Extracting relations with integrated information using kernel methods. In Procs. of ACL.
Jun Zhu, Zaiqing Nie, Xiaojiang Liu, Bo Zhang, and Ji-Rong Wen. 2009. StatSnowball: a statistical approach to extracting entity relationships. In WWW '09: Proceedings of the 18th international conference on World Wide Web, pages 101-110, New York, N.Y., USA. ACM.

I/We claim:

1. A method for learning open patterns within a corpus of text, the method comprising:
for seed tuple and sentence pairs, creating a candidate pattern by:
extracting a dependency path of the sentence connecting the words of the arguments and the relation of the seed tuple; and
annotating dependency path with the word of the relation and a part-of-speech constraint; and
when a candidate pattern is a syntactic pattern, generalizing the candidate pattern to unseen relations and preposition to generate an open pattern; and
when a candidate pattern is not a syntactic pattern, converting lexical constraints of the candidate patterns with similar syntactic restrictions on the relation word into a list of words of sentences with the candidate pattern to generate an open pattern.
